(19) United States
(12) Patent Application Publication
(10) Pub. No.: US 2014/0320675 A1
(43) Pub. Date: Oct. 30, 2014

(54) Camera Capable of Connecting to Mobile Devices, and Operational Methods Thereof

(71) Applicants: Sintai Optical (Shenzhen) Co., Ltd., Shenzhen City (CN); Asia Optical International Ltd., Tortola (GB)

(72) Inventor: Hsiang-Yin Lin, Taichung (TW)

(73) Assignees: Sintai Optical (Shenzhen) Co., Ltd., Shenzhen City (CN); Asia Optical International Ltd., Tortola (GB)

(21) Appl. No.: 14/253,892

(22) Filed: Apr. 16, 2014

(30) Foreign Application Priority Data
Apr. 26, 2013 (TW) 102114983

(51) Int. Cl. H04N 5/232

(52) U.S. Cl. CPC H04N 5/23222
USPC 348/207.1

(57) ABSTRACT

A camera capable of connecting to mobile devices and an operational method thereof are provided. The mobile devices are capable of wirelessly connecting to the camera to view related data in the camera. The camera includes a wireless transceiver receiving connection requests from a plurality of mobile devices, a display unit, and a processing unit displaying the mobile devices by the display unit according to the connection requests, receiving a selection corresponding to a plurality of sharing mobile devices within the mobile devices and transmitting data of the camera to the sharing mobile devices via the wireless transceiver so that the data are displayed by the sharing mobile devices.

### BACKGROUND OF THE INVENTION

1. Field of the Invention

The invention relates to a camera and an operational method thereof, and more particularly to a camera capable of connecting to mobile devices and an operational method thereof, wherein the mobile devices are capable of wirelessly connecting to the camera to view related data in the camera.

2. Description of the Related Art

As technologies have been rapidly developed in recent years, various electronic devices become necessary for people's daily life. For example, compact and light-weighted digital cameras are often used to take photos which can be viewed and processed in certain devices such as a computer system.

Some digital cameras have a remote controlling function, whereby a user can control the digital cameras with a remote control to take photos. Conventionally, signal transmission between the camera and the remote control is performed by infrared ray which has directionality. Therefore, a user can remotely control the camera only in a specific direction and within a limited distance. In addition, the remote controlling function of a conventional camera is limited to photo shooting due to properties and ability of the controller, and other remote controlling functions of a conventional camera have not been developed.

As described above, various electronic devices have become necessary for people's daily life, such as smart phones, mobile phones, personal digital assistants, global positioning system and laptops. If the digital cameras can be connected to or controlled by various mobile devices, then it is more convenient for a user to use the digital cameras. In addition, if the applications between digital cameras and the mobile devices are increased, the digital camera may become more recreational and applicable.

### BRIEF SUMMARY OF THE INVENTION

The invention provides a camera capable of connecting to mobile devices and an operational method thereof, wherein the mobile devices are capable of wirelessly connecting to the camera to view related data in the camera. The camera in accordance with an exemplary embodiment of the invention includes a wireless transceiver receiving connection requests from a plurality of mobile devices, a display unit, and a processing unit displaying the mobile devices by the display unit according to the connection requests, receiving a selection corresponding to a plurality of sharing mobile devices within the mobile devices and transmitting data of the camera to the sharing mobile devices via the wireless transceiver so that the data are displayed by the sharing mobile devices.

In the exemplary embodiment, the processing unit further receives a selection corresponding to a master mobile device within the sharing mobile devices, wherein the wireless transceiver receives a control of the master mobile device on the camera wirelessly to generate the data.

In the exemplary embodiment, the control of the master mobile device on the camera includes a control of lens movement, focusing, photographing, aperture regulation or shutter regulation, and the data comprises at least one image generated in accordance with the control.

In the exemplary embodiment, the master mobile device selects one specified mobile device from the mobile devices except the sharing mobile device, the processing unit transmits the data to the specified mobile device via the wireless transceiver, the data are edited by the specified mobile device, and the edited data are transmitted to a server through a network.

In the exemplary embodiment, the data are edited by at least one of the sharing mobile devices, and the edited data are transmitted to a server through a network.

In the exemplary embodiment, the mobile devices have names, the processing unit ranks the names of the mobile devices, and the display unit displays the ranked names of the mobile devices.

The operational method in accordance with an exemplary embodiment of the invention includes the following steps: receiving connection requests from a plurality of mobile devices via a wireless transceiver; displaying the mobile devices by a display unit according to the connection requests; receiving a selection corresponding to a plurality of sharing mobile devices within the mobile devices; and transmitting data of the camera to the sharing mobile devices via the wireless transceiver so that the data are displayed by the sharing mobile devices.

The exemplary embodiment further includes receiving a selection corresponding to a master mobile device within the sharing mobile devices; and receiving a control of the master mobile device on the camera via the wireless transceiver to generate the data.

In the exemplary embodiment, the control of the master mobile device on the camera comprises a control of lens movement, focusing, photographing, aperture regulation or shutter regulation, and the data comprises at least one image generated in accordance with the control.

The exemplary embodiment further includes: receiving a selection corresponding to one specified mobile device from the mobile devices except the sharing mobile device; and transmitting the data to the specified mobile device via the wireless transceiver, wherein the data are edited by the specified mobile device, and the edited data are transmitted to a server through a network.

The exemplary embodiment further includes: editing the data with at least one of the sharing mobile devices; and transmitting the edited data to a server in a network.

The exemplary embodiment further includes: ranking names of the mobile devices; displaying the ranked names of the mobile devices by the display unit.

The camera of the invention can be connected wirelessly to a plurality of mobile devices, whereby the mobile devices can display data in the camera and/or a master mobile device controls the camera to provide the data for other sharing mobile devices. In addition, the data can be edited by the sharing mobile device, and the edited data can be transmitted to a cloud server through a network.

The operational method of the invention can be performed by a program which can be loaded in a machine, and the machine becomes a device to perform the invention.

A detailed description is given in the following embodiments with reference to the accompanying drawings.

### BRIEF DESCRIPTION OF THE DRAWINGS

The invention can be more fully understood by reading the subsequent detailed description and examples with references made to the accompanying drawings, wherein:

FIG. 1 depicts a camera of the invention connected to a plurality of mobile devices;

FIG. 2 is a schematic view of a camera of the invention;

FIG. 3 is a flow chart of an operational method in accordance with an embodiment of a camera of the invention;

FIG. 4 is a flow chart of an operational method in accordance with another embodiment of a camera of the invention;

FIG. 5 is a flow chart showing data processing method between a mobile device and a camera;

FIGS. 6A and 6B show operation of a camera of the invention; and

FIG. 7 is a flow chart of an operational method in accordance with another embodiment of a camera of the invention.

### DETAILED DESCRIPTION OF THE INVENTION

The following description is of the best-contemplated mode of carrying out the invention. This description is made for the purpose of illustrating the general principles of the invention and should not be taken in a limiting sense. The scope of the invention is best determined by reference to the appended claims.

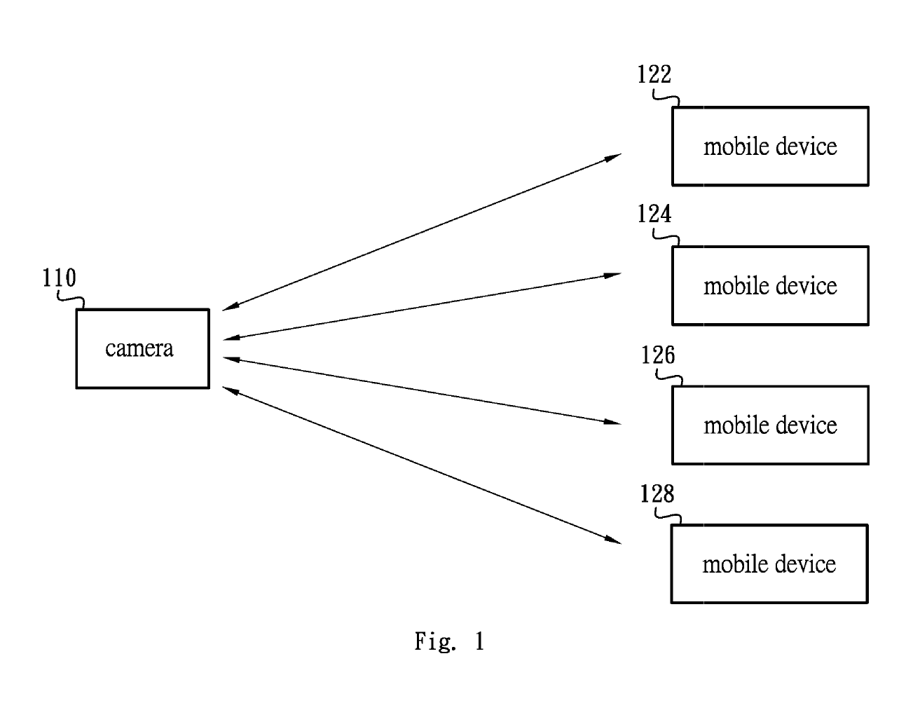

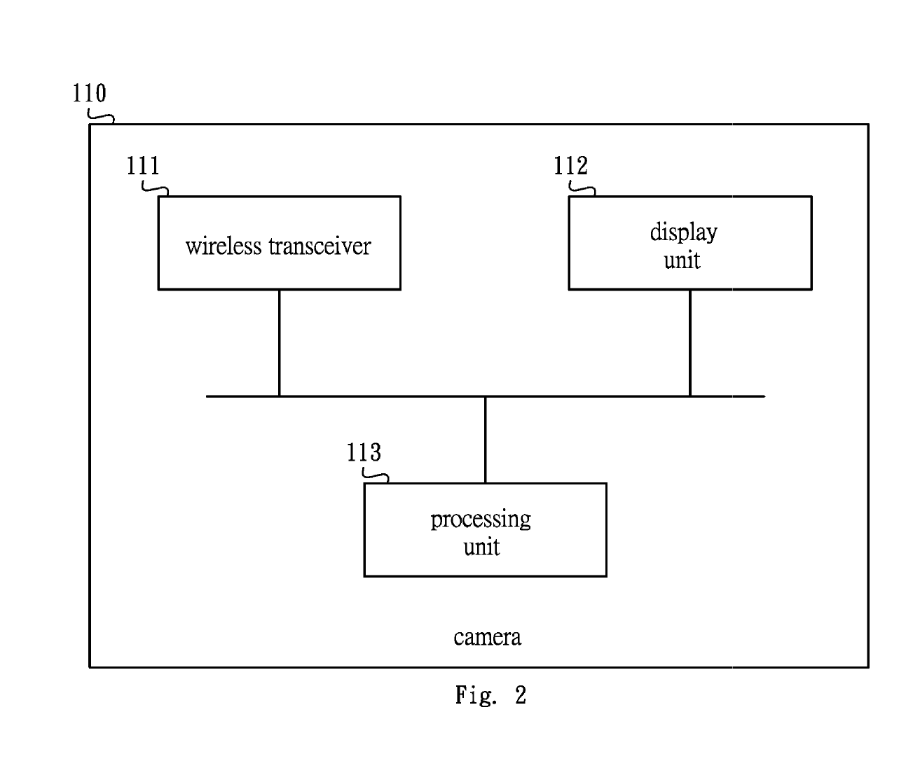

Referring to FIG. 1, a camera 110 of the invention is optionally connected to a plurality of mobile devices 122, 124 and 126. Referring to FIG. 2, the camera 110 includes a wireless transceiver 111, a display unit 112, a processing unit 113 and a control unit 114. The wireless transceiver 111 performs a wireless communication protocol such as infrared ray, WiFi and/or Bluetooth communication protocol to communicate with other electronic devices performing an identical wireless communication protocol. The display unit 112 displays related data of the camera 110 such as images, interfaces and/or data. The camera 110 is controlled by a control unit 114 which can be a plurality of buttons for photographing, displaying or setting. It is noted that the control unit 114 further includes a touch device (not shown) to detect the contact or touch on a surface of the touch device. In an embodiment, the touch device can be combined with the display unit 112 to constitute a touch display unit by which a user can view or input data. The processing unit 113 controls software and hardware operations of the camera 110.

It is noted that in some embodiments the mobile devices can be electronic devices having wireless connecting functions such as mobile phones, smart phones, personal digital assistants, global positioning systems, tablets or laptops. The mobile devices have a wireless connecting module performing a wireless communication protocol such as infrared ray, WiFi and/or Bluetooth communication protocol to send connection requests to the camera 110. The camera 110 can optionally connect to the mobile devices which send the connection request according to the received connection requests, and the related data of the camera 110 such as configurations and images of the camera 110 can be displayed by the mobile device.

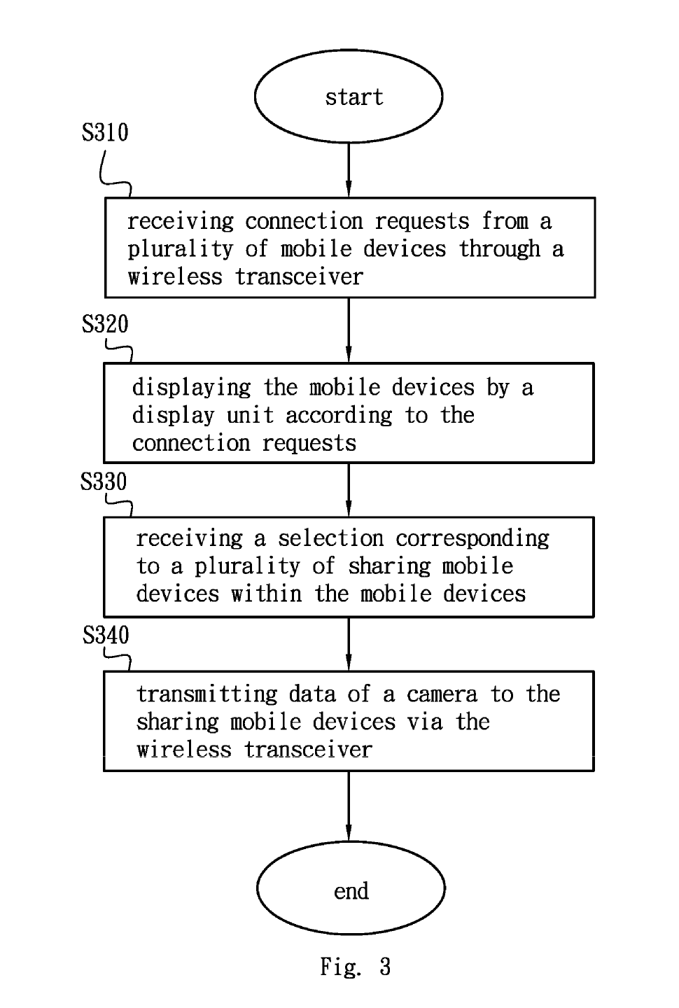

Referring to FIG. 3, the operational method of a camera is applicable to a digital camera having wireless connecting functions. In this embodiment, there are several mobile devices connecting to a camera for displaying related data of the camera.

In step S310, the wireless transceiver 111 of the camera 110 receives connection requests from a plurality of mobile devices. It is noted that the wireless transceiver 111 performs a wireless communication protocol to communicate wireless with other electronic devices performing the identical wireless communication protocol. The mobile device can be any electronic devices having wireless connecting functions, such as mobile phones, smart phones, personal digital assistants, global positioning systems, tablets and laptops. The mobile devices perform a wireless communication protocol such as infrared ray, WiFi and/or Bluetooth communication protocol to send connection requests to the camera 110. In step S320, the display unit 112 of the camera 110 displays the mobile devices which send the connection requests. It is noted that in some embodiments, the mobile devices can be ranked by the processing unit 113 and displayed by the display unit 112 according to the sending sequence of the connection requests. In other embodiments, the mobile devices can be ranked by the processing unit 113 and displayed by the display unit 112 according to a name of the mobile device such as according to alphabetical order. In step S330, the camera 110 receives a selection corresponding to sharing mobile devices within the mobile devices. It is noted that in some embodiments, the selection is input by buttons of the camera 110. As described above, the display unit 112 of the camera 110 can be a touch display unit. In some embodiments, the selection corresponding to the sharing mobile devices is done by the touch display unit. In step S340, when the selection corresponding to the sharing mobile devices is accomplished, the data of the camera 110 such as previewed images or images generated by photographing are transmitted to the sharing mobile device by means of the wireless transceiver 111 so that the data can be displayed by the sharing mobile devices.

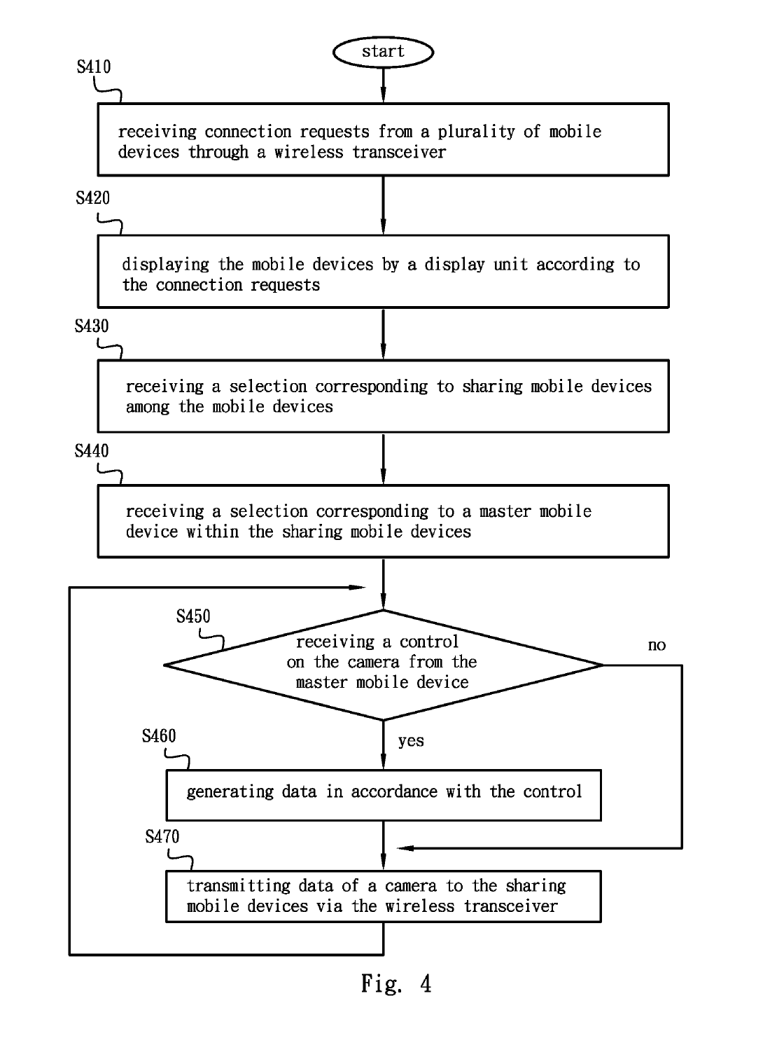

Referring to FIG. 4, the operational method for a camera of the invention is also applicable for a digital camera having wireless connecting function. In this embodiment, a plurality of mobile devices can be connected to the digital camera, wherein a mobile device is selected to be a master mobile device to control the digital camera.

In step 410, the camera 110 receives connection requests from a plurality of mobile devices. Similarly, the wireless transceiver 111 performs a wireless communication protocol such as infrared ray, WiFi and/or Bluetooth communication protocol to communicate with other electronic devices performing an identical wireless communication protocol. The mobile device can be electronic devices having wireless connecting functions such as mobile phones, smart phones, personal digital assistant, global positioning system, tablets or laptops. The mobile devices perform a wireless communication protocol such as infrared ray, WiFi and/or Bluetooth communication protocol to send connection request to the camera 110. In step S420, the display unit 112 of the camera 110 displays the mobile devices which send the connection requests. Similarly, in some embodiments, the mobile devices can be ranked by the processing unit 113 and displayed by the display unit 112 according to the sending sequence of the connection requests. Similarly, in other embodiments, the mobile devices can be ranked by the processing unit 113 and displayed by the display unit 112 according to a name of the mobile device such as according to alphabetical order. In step S430, the camera 110 receives a selection corresponding to sharing mobile devices within the mobile devices. It is noted that in some embodiments, the selection is input by buttons of the camera 110. As described above, the display unit 112 of the camera 110 can be a touch display unit. In some embodiments, the selection corresponding to the sharing mobile devices is done by the touch display unit. In step 440, the camera 110 receives a selection corresponding to a master mobile device within the sharing mobile devices. Similarly, the selection corresponding to the master mobile device is input by button and/or touch display unit of the camera 110. In step S450, it is determined whether a control of the master mobile device is received by the wireless transceiver 111. It is noted that in some embodiments, the control of the master mobile device includes a control of lens movement, focusing, photographing, aperture regulation and/or shutter regulation. When the wireless transceiver 111 does not receive the control of the master mobile device on the camera 110 (“No” in the step S450), the process enters step S470. When the wireless transceiver 111 receives the control on the camera 110 from the master mobile device (“Yes” in the step S450), the process enters step S460 to generate data such as an image in accordance with the control on the camera 110. In step 470, the data generated by the camera 110 are transmitted to the selected sharing mobile device via the wireless transceiver 111 to view the data on the sharing mobile device. After that, the process goes back to step S450.

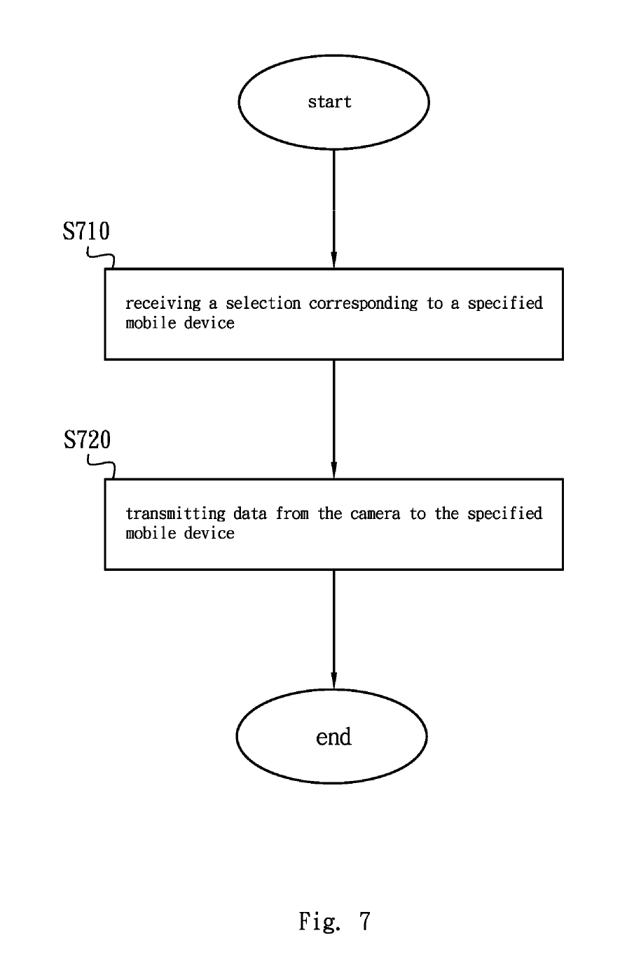

Referring to FIG. 7, the master mobile device can select mobile devices except the sharing mobile devices to provide the related data of the camera 110 for the selected mobile devices. In step S710, the master mobile device is connected to the camera 110, and at least one specified mobile device is selected by the master mobile device or the camera 110 from the mobile devices sending the connection requests except from the sharing mobile devices. In step S720, the camera 110 transmits data generated by the camera 110 to the specified mobile device for utilization (e.g. viewing).

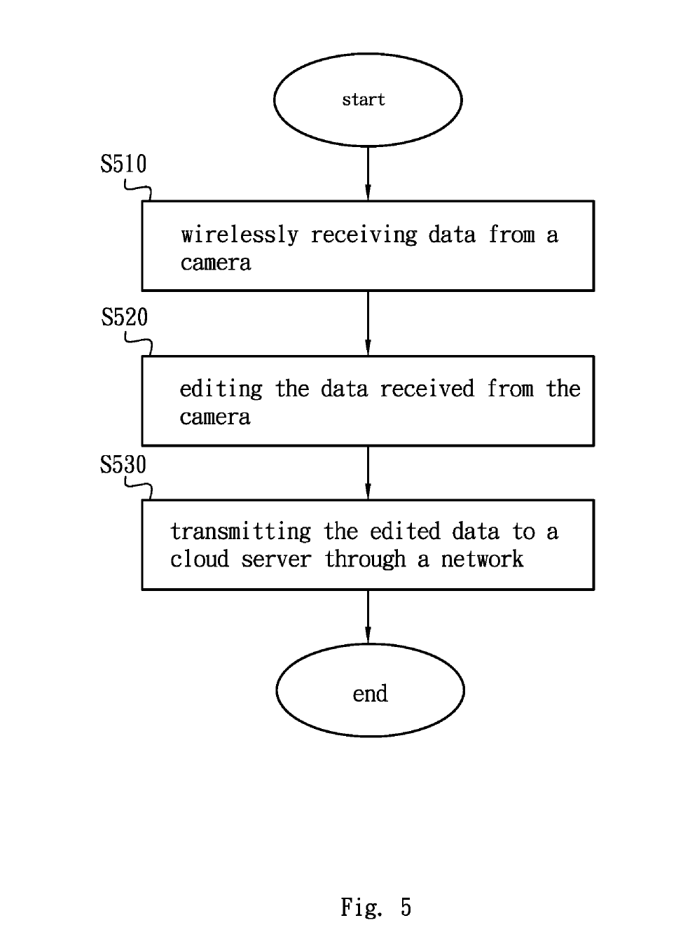

Referring to FIG. 5, in step S510, a sharing mobile device receives data, such as images, from the camera 110 wirelessly. In step S520, the data received from the camera 110 are edited by the sharing mobile device. In step S530, the edited data are transmitted to a cloud server through a network. In some embodiments, the server can be a cloud server. It is noted that the master mobile device is capable of connecting to the camera 110 and selects at least one specified mobile device from the mobile devices sending connection requests except the sharing mobile devices. The camera 110 transmits data to the specified mobile device via the wireless transceiver 111 for viewing. In some embodiments, the specified mobile device edits data and transmits the edited data to a server through a network.

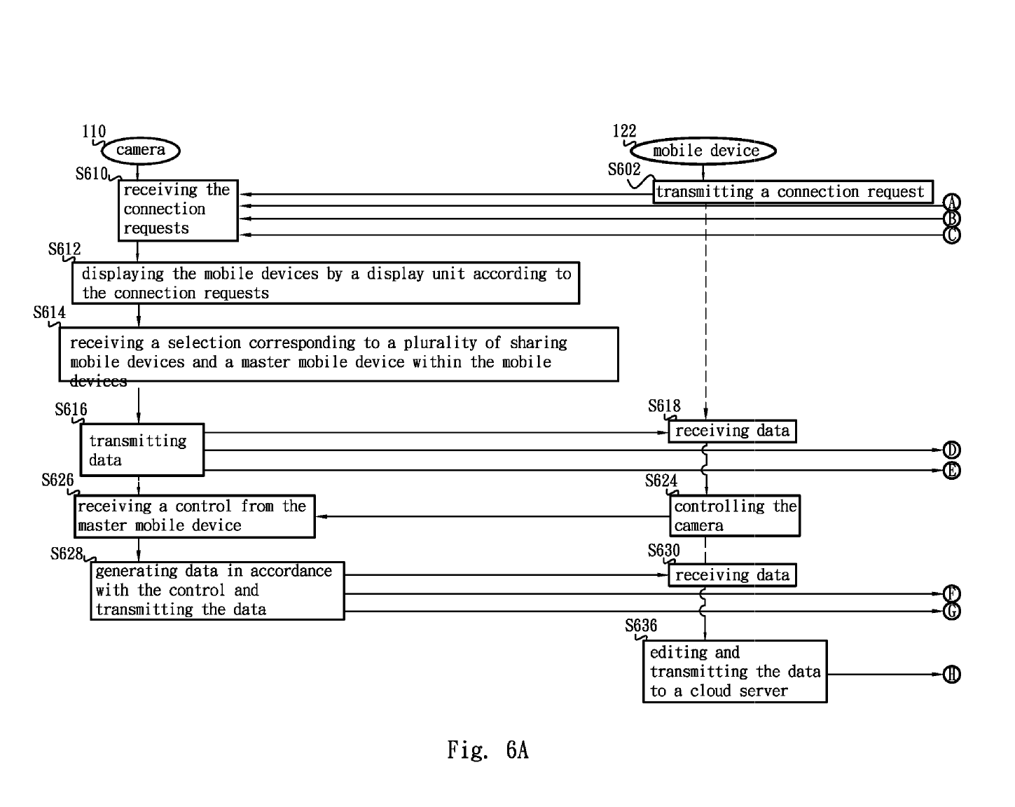

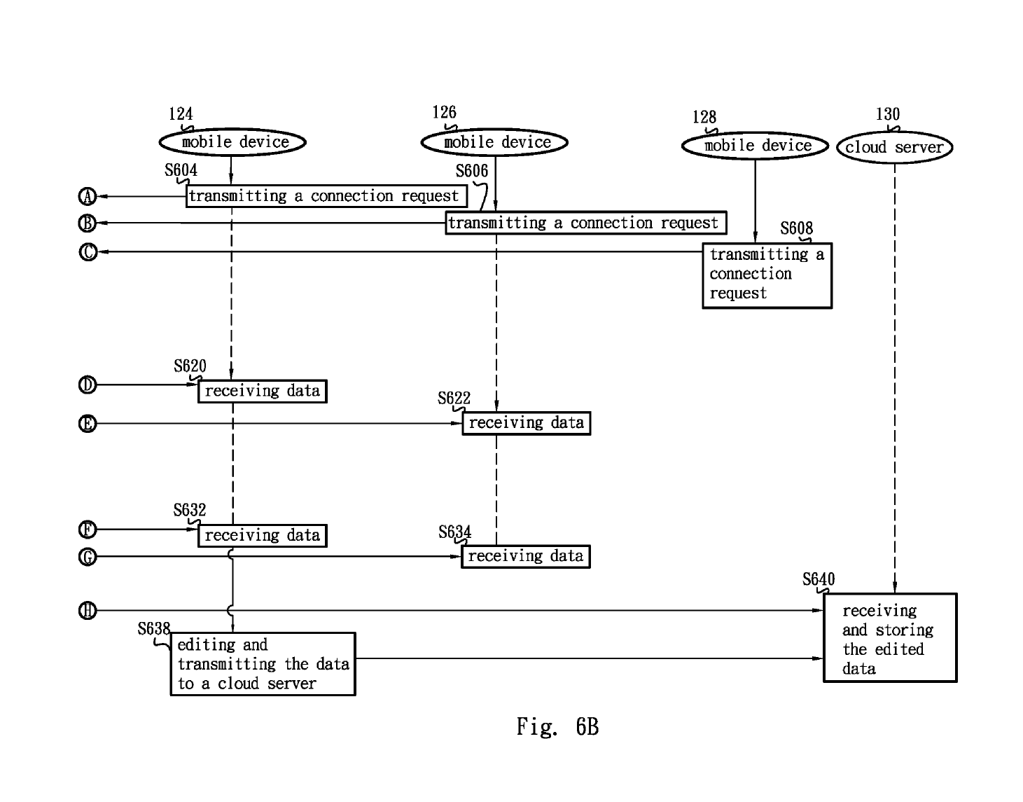

Referring to FIGS. 6A and 6B, the mobile devices 122, 124, 126 and 128 send connection requests to the camera 110 in steps S602, S604, S606 and S608 respectively. In step S610, the camera 110 receives connection requests from the mobile devices 122, 124, 126 and 128. In step S612, the camera 110 displays mobile devices sending connection requests on the display unit 112 according to the connection requests. In some embodiments, the mobile devices sending connection requests are displayed by the display unit 112 according the sending sequence of the mobile devices. In some embodiments, the mobile devices are ranked according to name, such as alphabetical order and displayed by the display unit 112. In step S614, the camera 110 receives a selection corresponding to a plurality of sharing mobile devices within the mobile devices and a selection corresponding to a master mobile device within the sharing mobile devices. In some embodiment, the selection corresponding to the sharing mobile devices and the master mobile device is accomplished by buttons of the camera 110. In addition, in some embodiments, the selection corresponding to the sharing mobile devices and the master mobile device is accomplished by a touch display unit. It is noted that in this embodiment, the mobile devices 122, 124 and 126 are selected as sharing mobile devices and the mobile device 122 is further selected as the master mobile device. In step S616, the camera 110 wirelessly transmits data to the sharing mobile devices 122, 124, and 126. The sharing mobile devices 122, 124 and 126 receive data from the camera 110 in steps S618, S620 and S622. In some embodiments, the data transmitted from the camera 110 can be images in live view mode, quick view mode, review mode or setting information of the camera 110. In step S624, the master mobile device 122 controls the camera 110 wirelessly and sends the data related to the control to the camera 110. In step S626, the camera 110 wirelessly receives a control from the master mobile device 122 and generates the related data. In some embodiments, the control includes a control of lens movement, focusing, photographing, aperture regulation or shutter regulation. In step SS628, the camera 110 transmits the data to the sharing mobile devices 122, 124 and 126 wirelessly, and the sharing mobile devices 122, 124 and 126 receive the data from the camera 110 in steps S630, S632 and S634. The sharing mobile devices 122, 124 edit the received data in steps S636 and S638 respectively, and the edited data are transmitted to a cloud server 130 through a network. In this embodiment, it is optional that the received data are not edited by the sharing mobile device 126. In step S640, the cloud server 130 receives and stores the edited data from the sharing mobile devices 122 and 124. The data stored in the cloud server 130 can be viewed by related people to provide more fun in real time.

In some embodiments, the master mobile device 122 can select a mobile device to display and edit the data of the camera 110. For example, the mobile device 128 in FIG. 6B is not selected as a sharing mobile device. However, the master mobile device 122 can select the mobile device 128 as a specified mobile device to which the data of the camera 110 is transmitted wirelessly for viewing. Similarly, the specified mobile device 128 can edit the received data and transmits the edited data to the cloud server 130 through a network.

As described, the invention provides a camera connected to a plurality of mobile devices wirelessly, and the data of the camera can be displayed by the mobile devices. In addition, a master mobile device is capable of controlling the camera and providing data of the camera for other sharing mobile devices. Furthermore, the sharing mobile devices can edit the data and transmit the edited data to a cloud server through a network.

The operational method can be performed by a program which can be saved in a media such as a soft disc, optical disc, hard disc or other storage media readable by a machine (a computer). When the program is loaded by a machine, such as a computer, the machine becomes a device of the invention. The program can be transmitted by a transmission media such as wire, cable or optical fiber. When the program is received, loaded or executed by a machine, such as a computer, the machine becomes a device of the invention. When a specific processing unit is used, the program is combined with the processing unit as a device applied to a specific logic circuit.

While the invention has been described by way of example and in terms of preferred embodiment, it is to be understood that the invention is not limited thereto. To the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A camera for connecting to mobile devices, comprising:
a wireless transceiver receiving connection requests from a plurality of mobile devices;
a display unit; and
a processing unit displaying the mobile devices by the display unit according to the connection requests, receiving a selection corresponding to a plurality of sharing mobile devices within the mobile devices, and transmitting data of the camera to the sharing mobile devices via the wireless transceiver so that the data are displayed by the sharing mobile devices.

2. The camera as claimed in claim 1, wherein the processing unit further receives a selection corresponding to a master mobile device within the sharing mobile devices, and the wireless transceiver receives a control of the master mobile device on the camera wirelessly to generate the data.

3. The camera as claimed in claim 2, wherein the control of the master mobile device on the camera comprises a control of lens movement, focusing, photographing, aperture regulation or shutter regulation, and the data comprises at least one image generated in accordance with the control.

4. The camera as claimed in claim 2, wherein the master mobile device selects one specified mobile device from the mobile devices except the sharing mobile devices, the processing unit transmits the data to the specified mobile device via the wireless transceiver, the data are edited by the specified mobile device, and the edited data are transmitted to a server through a network.

5. The camera as claimed in claim 1, wherein the data are edited by at least one of the sharing mobile devices, and the edited data are transmitted to a server through a network.

6. The camera as claimed in claim 1, wherein the mobile devices have names, the processing unit ranks the names of the mobile devices, and the display unit displays the ranked names of the mobile devices.

7. An operational method of a camera, comprising:
receiving connection requests from a plurality of mobile devices via a wireless transceiver;
displaying the mobile devices by a display unit according to the connecting requests;
receiving a selection corresponding to a plurality of sharing mobile devices within the mobile devices; and
transmitting data of the camera to the sharing mobile devices via the wireless transceiver so that the data are displayed by the sharing mobile devices.

8. The operational method as claimed in claim 7 further comprising:
receiving a selection corresponding to a master mobile device within the sharing mobile devices; and
receiving a control of the master mobile device on the camera via the wireless transceiver to generate the data.

9. The operational method as claimed in claim 8, wherein the control of the master mobile device on the camera comprises a control of lens movement, focusing, photographing, aperture regulation or shutter regulation, and the data comprises at least one image generated in accordance with the control.

10. The operational method as claimed in claim 8 further comprising:
receiving a selection corresponding to one specified mobile device within the mobile devices except the sharing mobile devices; and
transmitting the data to the specified mobile device via the wireless transceiver, wherein the data are edited by the specified mobile device, and the edited data are transmitted to a server through a network.

11. The operational method as claimed in claim 7 further comprising:
editing the data with at least one of the sharing mobile devices; and
transmitting the edited data to a server through a network.

12. The operational method as claimed in claim 7 further comprising:
ranking names of the mobile devices; and
displaying the ranked names of the mobile devices by the display unit.
